(19) United States
(12) Patent Application Publication
(10) Pub. No.: US 2014/0089200 A1
(43) Pub. Date: Mar. 27, 2014

(54) Method and Apparatus for Synergistic Online Services

(71) Applicants: Janice L. Hazel, Lake Oswego, OR (US); David H. Madden, Portland, OR (US)

(72) Inventors: Janice L. Hazel, Lake Oswego, OR (US); David H. Madden, Portland, OR (US)

(21) Appl. No.: 13/626,114

(22) Filed: Sep. 25, 2012

(51) Int. Cl. G06F 21/00; G06Q 20/22

(52) U.S. Cl. 705/51; 705/39

(57) ABSTRACT

An online service that stores data securely for customers of businesses. The data is uploaded by the business and stored in a encrypted form that only the customer can cover.

### CONTINUITY AND CLAIM OF PRIORITY

This is an original U.S. patent application that claims priority to U.S. Provisional Patent Application No. 61/539,434, filed 26 Sep. 2011.

### FIELD

The invention relates to distributing benefits and costs of an online service among a number of parties having defined commercial relationships.

### BACKGROUND

The legal systems of many countries support business transactions by allowing individuals and other entities to make and enforce contracts with one another. A basic contract is simply a promise, or a set of promises, among two or more parties. For example, one may create an implicit contract by ordering dinner at a restaurant; the promise is “if you serve me a hamburger and fries, I will pay you.” Of course, contracts can be much more complex, and can involve the rights and obligations of many people. However, the basic idea of promises between parties provides a remarkably powerful way of analyzing a wide range of commercial interactions.

One area where careful contract analysis pays off is in online services (i.e., services and intangible goods provided or delivered through a communication system). In many situations, the economics of providing such goods or services is different enough from traditional physical transactions that one's intuitions about how things work will be significantly wrong. For example, although it is not possible to sell the same physical item to two buyers, each of whom is to receive possession and full control of the item, it is trivial to sell an electronic document to two different buyers, each of whom receives the same thing and can do whatever he likes with it, without interfering with what the other buyer received. Similarly, for physically-delivered services, providing a service to one client is usually incompatible with providing the same (or a different) service to another client at the same time. However, for online services, there is usually much less interference between services provided to simultaneous clients.

In economic terms, the marginal cost to provide an online good or service is often very small. This leads to challenges in structuring business transactions in a way that is acceptable to all the participants. These challenges can be seen, for example, in the problems music and computer software producers face from copyright infringers.

New ways of structuring commercial and contractual relationships may be of significant value in the field of online goods and services.

### SUMMARY

Embodiments of the invention combine multiple different online services, which appeal to (or are principally used by) different entity types, where the combination presents a compelling value proposition to all the participants, although the individual services may not do so.

### BRIEF DESCRIPTION OF DRAWINGS

Embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

FIG. 1 shows an overview of interactions between relevant parties according to an embodiment of the invention.

FIG. 2 is a flow chart outlining some of the events and actions that are found in an embodiment.

FIG. 3 is a flow chart outlining user enrollment according to an embodiment.

FIG. 4 is a flow chart explaining how one enrolled user can send a file securely to another enrolled user.

FIG. 5 is a flow chart describing the retrieval and decryption of a securely-stored file.

### DETAILED DESCRIPTION

Embodiments of the invention combine two different online services, targeting two different groups of users, where the members of the groups of users have an exogenous relationship (apart from their mutual participation in using the services of an embodiment). In many embodiments, the two different groups are (1) service- or goods-providing businesses; and (2) the customers of those businesses. In one embodiment the two different online services are (1) secure online storage of information; and (2) online advertising.

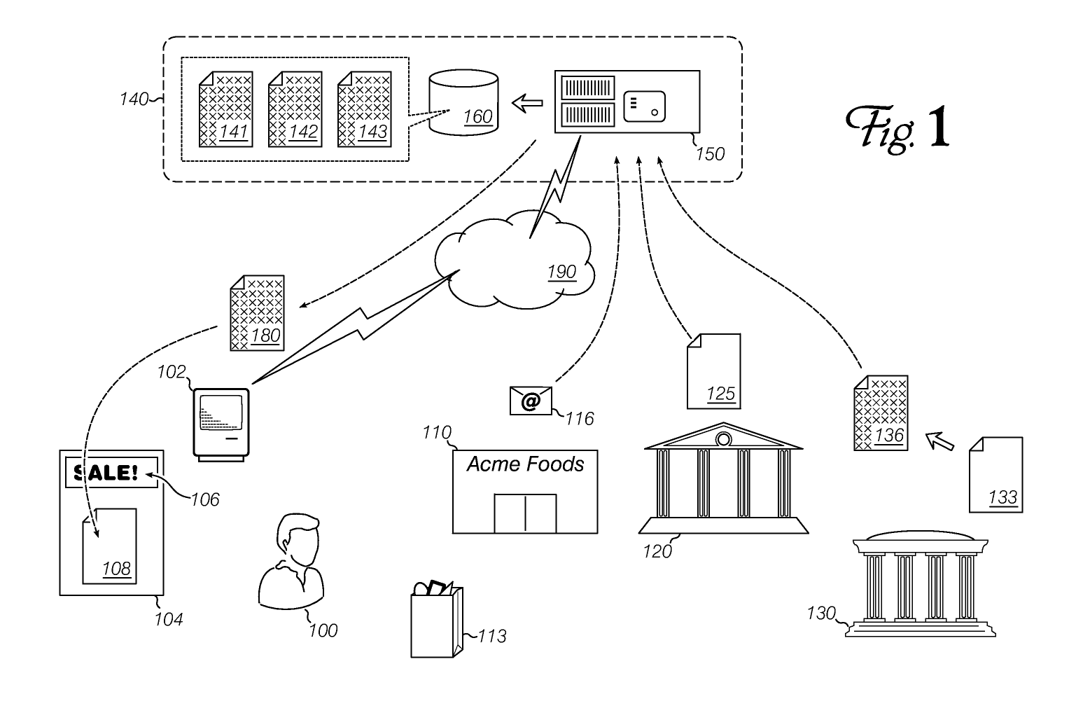

FIG. 1 shows participants in an embodiment, and interactions among them. A consumer 100 transacts business with a number of companies, such as grocery store 110, bank 120 and law firm 130. For example, consumer 100 may purchase groceries 113 from grocery store 110. Instead of giving a paper receipt (register tape) to user 100, grocery store 110 transmits an electronic record 116 of the purchase (including, for example, items, quantities and prices) to a remote service provider 140. This information may be transmitted by electronic mail, in unencrypted (plaintext) form. When it arrives at service provider 140, a computer 150 encrypts the information and stores it on a hard disk or other storage medium 160 as encrypted document 141.

Similarly, bank 120 may prepare an account statement or other informational document 125 for user 100, but instead of printing and mailing the document, bank 120 transmits the information to service provider 140. This transmission can also be made by electronic mail, or by another data transport facility such as the File Transfer Protocol (“FTP”), Remote Copy (“rcp”) or Secure Copy (“scp”). In this example, bank 120 has not encrypted document 125, so computer 150 encrypts it before storing it as encrypted document 142. (It is appreciated that presently, banks rarely transmit account statements electronically, even if a consumer signs up for “electronic statements.” Instead, the bank merely transmits a notification that a new statement is available for viewing, and the consumer may access the statement at an online service portal operated by the bank. Critically, in this model, the consumer does not receive a copy of the statement at the time it is produced. Since the statement must be viewed at a portal operated by the bank, the consumer must access the portal and make a separate copy of the statement if he wishes to have a transaction record that is not subject to later alteration by the bank.)

Law firm 130 may prepare a document 133 for consumer 100. Document 133 may be, for example, a contract, will, or legal memorandum. Since document 133 may contain sensitive or private information, law firm 130 encrypts it to produce encrypted document 136, which is sent to service provider 140. Again, any suitable data transport mechanism can be used to transmit the encrypted document. When encrypted document 136 is received, computer 150 stores it on its storage medium 160 as encrypted document 143.

Later, consumer 100 may wish to review one of the documents stored for him by one of his business partners. Using his personal computer 102, the consumer authenticates himself and requests one of the documents. The requested document 180, still encrypted, is sent to personal computer 102 where it is decrypted and displayed as plaintext document 108 on a user interface 104. If the requested document 180 was provided by a business with a subscriber relationship with the remote service provider 140, an advertisement or other message 106 from that business may be displayed to consumer 100.

It is appreciated that electronic communications are often encrypted to protect their contents against eavesdropping, regardless of whether the data being transmitted are also encrypted. For example, the Secure Sockets Layer (“SSL”) protocol is often used to protect data in transit between computers. However, such link-level protocols automatically encrypt data accepted for transmission, and decrypt the data once it has arrived at its destination, so for purposes of embodiments of the invention, this sort of encryption is not considered to be significant. Indeed, if a document or other information is encrypted before transmission, then it does not matter very much whether a secure communication protocol is used (although it is usually better to use secure channels whenever they are available).

The participants and interactions described with reference to FIG. 1 may seem familiar or unexceptional against the backdrop of contemporary online activities and development. After all, an enormous number of data transfer and storage services are in use, and online advertising is a common way for a service provider to earn revenue with which it can fund the provision of the service. For example, the Internet search company Google, Inc. of Mountain View, Calif., offers a data search service for free to any visitor, and earns some of the income required to operate the search service by selling advertising placements to businesses, which wish to display their messages near the results for particular search terms.

Embodiments of the invention differ from this conventional model in several critical respects. First, the service provider in an embodiment has formal, contractual relationships with both the consumer (on whose behalf information is stored) and the subscriber (which produces and uploads the information). The service provider's contractual promise to the consumer is to accept data sent to the consumer, store it in encrypted form with reasonable care, and send it to the consumer upon request. A basic level of service may be offered to consumers without charge, while enhanced services (e.g., increased amounts of data, faster access or more sophisticated encryption algorithms) may be available upon payment of a fee.

The service provider's contractual promise to a (business) subscriber is to accept data sent by the subscriber to a consumer, to store it in encrypted form with reasonable care, to send it to the consumer (upon the consumer's request), and to display a message or other information from the subscriber to the consumer when the consumer requests the data uploaded by the subscriber.

Separately, the service provider's contractual promises are similar to those of a free electronic mail service provider or of an online advertising delivery agency, but in an embodiment of the invention, the types of data accepted, the handling of the data, and the exogenous relationship between the consumer and the business subscriber, distinguish the claimed service from any existing analogue.

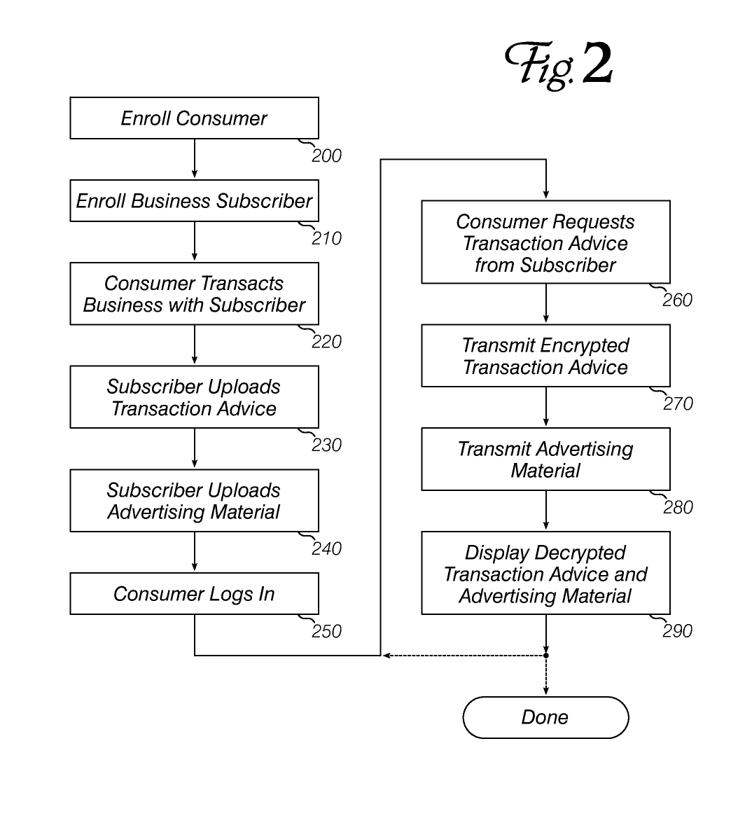

FIG. 2 outlines some of the steps performed (or events that occur) during the operation of an embodiment of the invention. Although the items are shown and described in a particular sequence, it should be apparent that many steps or events can be performed (or can occur) in a different order. The participants in this embodiment are the consumer (e.g. 100 in FIG. 1), a business subscriber (e.g., 110 in FIG. 1), and a service provider (e.g., 140 in FIG. 1). The consumer enrolls to use the service (200), perhaps by supplying his name, address, phone, electronic mail address and other information, selecting a user name and password, or completing other similar tasks. The business subscriber also enrolls to use the service (210), perhaps by supplying similar information, and also (in many cases) agreeing to pay a subscription fee for the right to participate in the embodiment.

Next, the consumer participates in a transaction with the business subscriber (220). For example, the consumer may purchase an item or service from the subscriber. The details of this transaction are not important to the operation of an embodiment of the invention; all that matters is that the consumer and subscriber have an exogenous relationship that is in the nature of customer-seller.

Now, the subscriber uploads an electronic document to the service provider (230). This electronic document may be an itemized receipt, an invoice, a payment acknowledgement, or some other document. It may relate to the business transaction conducted at 230, or may concern some other matter of interest to the consumer and/or the business subscriber. In some scenarios, the electronic document is a plain text message, while in others, it may be an optical scan of a physical paper document, a digital photograph, or a digitized audio recording. The business subscriber may, but need not, encrypt the document before uploading it. If the document is sent unencrypted (notwithstanding that it may be sent over an encrypted communication channel, as discussed above), then the service provider will encrypt it using a public key of the consumer before storing it.

Separately, the business subscriber uploads advertising material (240) to the service provider. This material may be encrypted, but in most embodiments, such encryption is not necessary or beneficial.

Later, the consumer logs into his previously-created account at the service provider (250) to view information uploaded for him by the businesses with which he has conducted transactions. Using a user interface at his computer, he may request the earlier-uploaded transaction advice from the business subscriber (260), and the service provider will transmit that document (270). Recall that the document was either encrypted by the business subscriber prior to uploading, or encrypted by the service provider after receipt, so the document transmitted to the consumer is encrypted. In addition, advertising material from the business subscriber is transmitted to the consumer (280).

At the consumer's computer, the transaction advice is decrypted and displayed for the consumer's review (290). The advertising material may also be displayed at this time. Thereafter, the consumer may request and review other information that has been uploaded for him (some of which may be accompanied by advertising material provided by the business that uploaded the information). When the consumer has completed his review, he may log out of the service.

The building-block online services described above (i.e., secure online storage of information produced and uploaded by a business for its customer; and online advertising directed to the customer) complement each other and give rise to an unexpectedly favorable economic outcome. The secure storage portion is convenient for the user, but services offering only online storage have not found great market acceptance—consumers are unwilling to pay much for such services (although they are sometimes willing to use the limited version of a service that is offered on a “freemium” basis). Similarly, although online advertising is widespread and used by many businesses, it is usually inexactly targeted and consequently of only modest efficacy.

In contrast, by combining secure online data storage with online advertising according to an embodiment of the invention, economic incentives are aligned so that consumers can obtain convenient data storage (as well as the additional service of automatic data upload) for free, while the businesses obtain closely targeted advertising opportunities (i.e., the ability to present information and advertisements to exactly the consumers who were their past customers). In addition, the businesses can avoid the expense and delay of printing and delivering paper-based transaction notices (receipts, invoices, account statements and so on). Thus, although the cost and benefit of the inventive service, to the business subscriber, seems similar to that of advertising, it also yields savings in streamlining other business processes.

Although embodiments of the invention can be used by any consumer, and by any business that presently either advertises to consumers, or prints and delivers any sort of document to its customers, embodiments may be particularly useful to lawyers, accountants and similar professionals. These service providers often produce paper documents for their clients (e.g., contracts, wills, tax returns and so on), and the documents commonly contain sensitive or confidential information. Thus, security is critical for any online storage system that accepts such documents. An embodiment of the invention can use the encryption and key management protocol disclosed in U.S. patent application Ser. No. 13/534,633, filed 27 Jun. 2012 by one of the inventors hereof. The disclosure of that application is incorporated by reference herein. This protocol can permit a lawyer, accountant or doctor (as well as any other sort of business) to upload information securely for its customers.

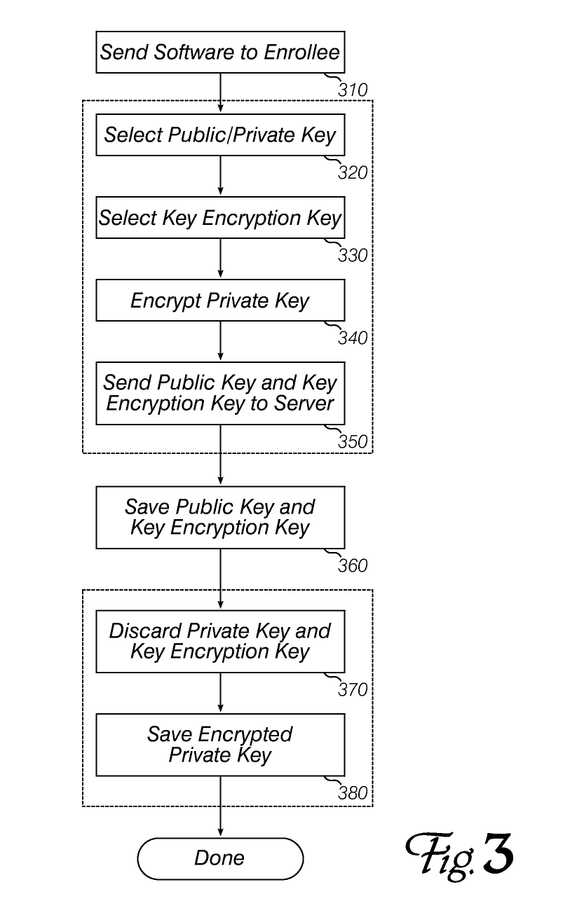

FIGS. 3-5 provide a “soup to nuts” outline of technical activities that occur in an embodiment of the invention. First, two users are enrolled. One user may be a consumer, while the other may be a business subscriber, but the general process may be quite similar between them. Referring to FIG. 3, the operator of the embodiment sends enrollment software to the enrollee (310). This software may be, for example, a JavaScript program that executes within the enrollee's computer.

The software causes the enrollee's computer to perform operations including: selecting a public/private key pair (320), such as an RSA public/private key pair. The enrollee's computer next selects a key encryption key (330). (In an alternative embodiment, the key-encryption key may be selected by the operator of an embodiment, or by a third party, and sent to the enrollee's computer.) The enrollee's computer encrypts the private key of the public/private keypair, using the key encryption key (340). Then the enrollee's computer sends the public key and the key encryption key to a server operated in connection with the embodiment (350). The public key and key encryption keys are stored there (360), along with other information collected about the enrollee.

Back at the enrollee's computer, the (unencrypted) private key and key encryption keys are discarded (370), and the encrypted private key is saved (380). After the enrollment process, neither the enrollee nor the embodiment operator can decrypt material encrypted with the public key, because neither has the private key in plaintext form. (The embodiment operator does not have the private key in any form, and the enrollee only has the encrypted private key.)

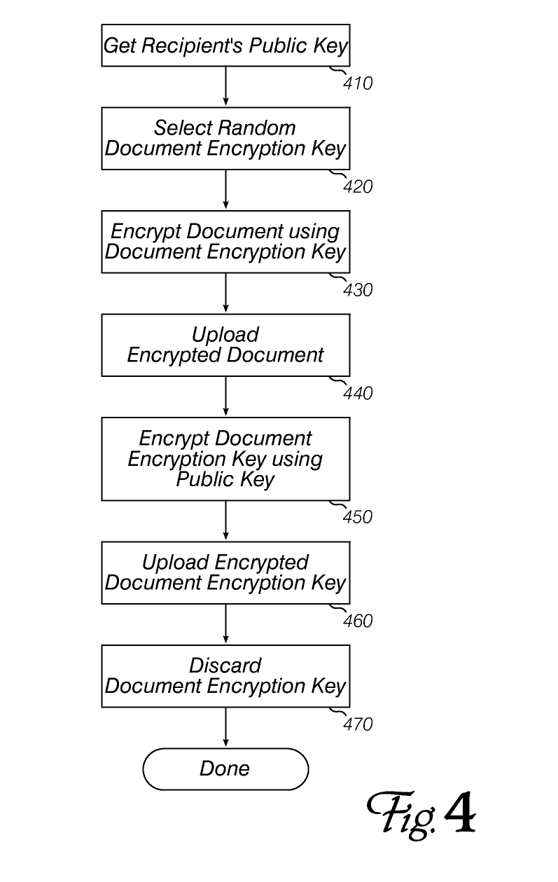

After two users enroll according to the procedure outlined with respect to FIG. 3, one can send a document securely to the other as described in FIG. 4. First, the sender obtains the recipient's public key (410). For example, the sender can get the key directly from the recipient, from a server operated in connection with the embodiment, or from another source that has a copy. (Since the public key is public, there is no reason to keep it secret.) Next, the sender selects a random document encryption key (420). The sender encrypts the document using the document encryption key (430) and then uploads the encrypted document (440).

Now, the sender encrypts the document encryption key using the recipient's public key (450), and then uploads the encrypted document encryption key (460). (The operator of the embodiment receives these uploads, and stores the encrypted data.) Finally, the sender discards the document encryption key (470), so no-one can recover the document plaintext from the encrypted document uploaded at 440. (It is appreciated that the sender had, and may keep, a plaintext copy of the document. An embodiment of the invention cannot prevent misuse of documents by entities that have plaintext copies of the documents to begin with.)

Note that all of the operations performed by a sender to encrypt and upload a document may be performed by software provided to the sender by the operator of the embodiment. For example, the operator may send a JavaScript program to the sender, and that program will execute at the sender's computer to perform the operations of FIG. 4.

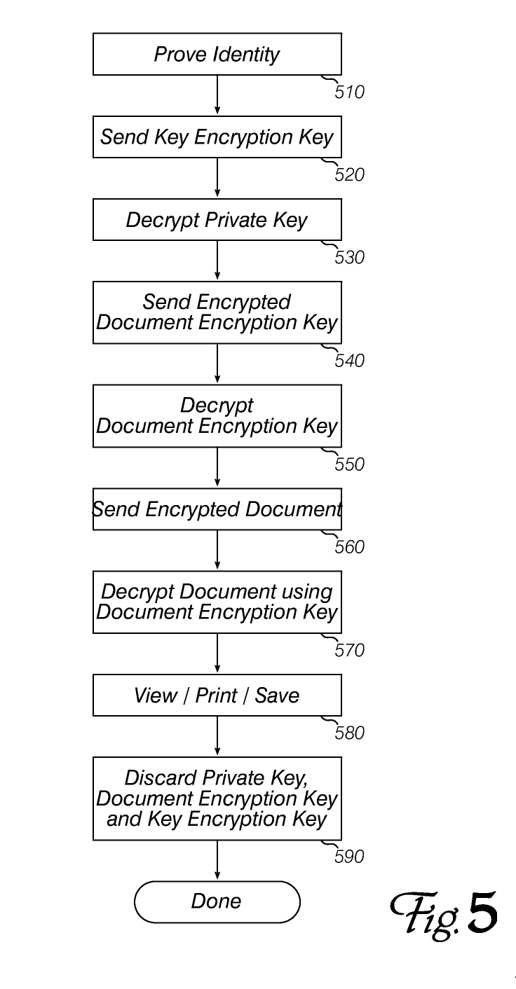

Finally, when the recipient of the document wishes to review it, he can proceed as outlined in FIG. 5. First, the recipient engages in an authentication exchange to prove his identity to the operator of the embodiment (510). For example, the recipient may provide a username and password, and preferably may provide a second authentication factor, such as the answer to a previously-selected personal question, or the currently-displayed value on a One Time Password (“OTP”) device. If the recipient can prove his identity to the satisfaction of the embodiment operator, then the embodiment operator sends the key-encryption key that was saved during enrollment (520; see also FIG. 3, 350).

The recipient uses the key encryption key to decrypt his saved, encrypted private key (530; also FIG. 3, 380), producing his plaintext private key. The server sends the encrypted document encryption key to the recipient (540; also FIG. 4, 460), and the recipient decrypts the document encryption key using his plaintext private key (550). Next, the server sends the encrypted document (560; also FIG. 4, 440), and finally, the recipient decrypts the document using the decrypted document encryption key (570) and can view, print or save the plaintext document on his computer (580). When the recipient is done using the various keys, he should discard them (590).

As with the operations performed by the sender, the recipient can also accomplish the tasks of FIG. 5 by using software sent by the operator of the embodiment. For example, the operator may send a JavaScript program to the recipient's browser, and the program, executing on the recipient's computer, performs all the key retrieval and decryption operations. Since all the operations (and all the exposed plaintext keys) are only present on the recipient's computer, the document is less likely to be exposed to or accessed by unauthorized parties.

The use of JavaScript programs in an embodiment is beneficial because a user is likely to have all the software necessary to interact with an embodiment (apart from the JavaScript programs) on his computer already. Since no separate download or installation is necessary, it may be easier for the user to begin using the embodiment, and it may be possible to use it from an unfamiliar computer.

An embodiment of the invention may be a machine-readable medium having stored thereon data and instructions to cause a programmable processor to perform operations as described above. In other embodiments, the operations might be performed by specific hardware components that contain hardwired logic. Those operations might alternatively be performed by any combination of programmed computer components and custom hardware components.

Instructions for a programmable processor may be stored in a form that is directly executable by the processor (“object” or “executable” form), or the instructions may be stored in a human-readable text form called “source code” that can be automatically processed by a development tool commonly known as a “compiler” to produce executable code. Instructions may also be specified as a difference or “delta” from a predetermined version of a basic source code. The delta (also called a “patch”) can be used to prepare instructions to implement an embodiment of the invention, starting with a commonly-available source code package that does not contain an embodiment.

In some embodiments, the instructions for a programmable processor may be treated as data and used to modulate a carrier signal, which can subsequently be sent to a remote receiver, where the signal is demodulated to recover the instructions, and the instructions are executed to implement the methods of an embodiment at the remote receiver. In the vernacular, such modulation and transmission are known as “serving” the instructions, while receiving and demodulating are often called “downloading.” In other words, one embodiment “serves” (i.e., encodes and sends) the instructions of an embodiment to a client, often over a distributed data network like the Internet. The instructions thus transmitted can be saved on a hard disk or other data storage device at the receiver to create another embodiment of the invention, meeting the description of a machine-readable medium storing data and instructions to perform some of the operations discussed above. Compiling (if necessary) and executing such an embodiment at the receiver may result in the receiver performing operations according to a third embodiment.

In the preceding description, numerous details were set forth. It will be apparent, however, to one skilled in the art, that the present invention may be practiced without some of these specific details. In some instances, well-known structures and devices are shown in block diagram form, rather than in detail, in order to avoid obscuring the present invention.

Some portions of the detailed descriptions may have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the preceding discussion, it is appreciated that throughout the description, discussions utilizing terms such as “processing” or “computing” or “calculating” or “determining” or “displaying” or the like, refer to the action and processes of a computer system or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, including without limitation any type of disk including floppy disks, optical disks, compact disc read-only memory (“CD-ROM”), and magnetic-optical disks, read-only memories (ROMs), random access memories (RAMs), eraseable, programmable read-only memories (“EPROMs”), electrically-eraseable read-only memories (“EEPROMs”), magnetic or optical cards, or any type of media suitable for storing computer instructions.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will be recited in the claims below. In addition, the present invention is not described with reference to any particular programming language. It will be appreciated that a variety of programming languages may be used to implement the teachings of the invention as described herein.

The applications of the present invention have been described largely by reference to specific examples and in terms of particular allocations of functionality to certain hardware and/or software components. However, those of skill in the art will recognize that novel and commercially-favorable combinations of online services can also be produced by software and hardware that distribute the functions of embodiments of this invention differently than herein described. Such variations and implementations are understood to be captured according to the following claims.

We claim:

1. A method comprising:
accepting a subscription payment from a first entity, said subscription payment to entitle the first entity to submit data to an online storage facility;
receiving an electronic document from the first entity, said electronic document to be stored at the online storage facility for a second entity; and
delivering the electronic document to the second entity.

2. The method of claim 1 wherein the second entity is a customer of the first entity.

3. The method of claim 1 wherein the second entity receives access to the online storage facility without making any payment.

4. The method of claim 1 wherein receiving the electronic document is receiving an encrypted electronic document, where an operator of the online storage facility does not possess a key to decrypt the encrypted electronic document.

5. The method of claim 1 wherein receiving the electronic document comprises:
receiving a plaintext electronic document;
encrypting the plaintext electronic document to produce a ciphertext electronic document; and
storing the ciphertext electronic document, wherein
an operator of the online storage facility cannot decrypt the ciphertext electronic document.

6. The method of claim 5 wherein encrypting the plaintext electronic document to produce a ciphertext electronic document comprises:
selecting a document encryption key; and
encrypting the document using the document encryption key;
the method further comprising:
encrypting the document encryption key using a public key of the second entity to produce an encrypted document encryption key;
discarding the document encryption key; and
storing the encrypted document encryption key.

7. The method of claim 1, further comprising:
receiving a second electronic document from a third entity, said second electronic document to be stored at the online storage facility for the second entity; and
delivering the second electronic document to the second entity.

8. The method of claim 1 wherein delivering comprises:
transmitting an advertising message provided by the first entity, to the second entity.

9. The method of claim 1, further comprising:
authenticating the second entity before performing the delivering operation.

10. The method of claim 9 wherein authenticating comprises validating a user name and password.

11. The method of claim 9 wherein authenticating comprises validating a time-varying One Time Password (“OTP”) value.

12. A method comprising:
transmitting an enrollment program to two enrolling users' computers, the enrollment program to cause each enrolling user's computer to perform operations comprising:
selecting a public/private key pair;
encrypting a private key of the public/private key pair with a key encryption key; and
sending a public key of the public/private key pair to a server, each enrolling user thereby becoming an enrolled user;
transmitting a document-sending program to a first of the two enrolled users, the document-sending program to cause the first enrolled user's computer to perform operations comprising:
retrieving the public key of the second enrolled user;
selecting a document encryption key;
encrypting a document using the document encryption key to produce an encrypted document;
encrypting the document encryption key using the public key of the second enrolled user to produce an encrypted document encryption key; and
sending the encrypted document and the encrypted document encryption key to a server; and
transmitting a document-access program to the second of the two enrolled users, the document-access program to cause the second enrolled user's computer to perform operations comprising:
transmitting information to prove the second enrolled user's identity;
receiving a key encryption key;
decrypting an encrypted private key to produce a plaintext private key;
receiving the encrypted document encryption key;
decrypting the encrypted document encryption key to recover the document encryption key;
receiving the encrypted document;
decrypting the encrypted document using the document encryption key to recover the document; and
displaying, printing or saving the document.

13. The method of claim 12, further comprising:
transmitting a message from the first enrolled user to be displayed for the second enrolled user while the second enrolled user is using the document-access program.

14. The method of claim 12 wherein the information to prove the second enrolled user's identity comprises a username, a password and a second authentication factor.

15. The method of claim 14 wherein the second authentication factor is a One-Time Password (“OTP”) value.

16. The method of claim 14 wherein the second authentication factor is an answer to a personal question.

17. The method of claim 12 wherein the enrollment program is a JavaScript program.

18. The method of claim 12 wherein the document-sending program is a JavaScript program.

19. The method of claim 12 wherein the document-access program is a JavaScript program.
